(19) United States
(12) Patent Application Publication
(10) Pub. No.: US 2010/0032327 A1
(43) Pub. Date: Feb. 11, 2010

(54) TOOL BOX

(76) Inventor: JIN-TSAI LAI, Taichung City (TW)

Correspondence Address: Chien-Hui Su, P. O. Box 70-121 Taichung, Taichung City, 40899, TW

(21) Appl. No.: 12/185,818

(22) Filed: Aug. 5, 2008

(51) Int. Cl. B25H 3/02

(52) U.S. Cl. 206/375

(57) ABSTRACT

A tool box includes a base. A rack is received in the base and pivotally connected to the base for positioning tools. A cover is pivotally connected to the base relative to the rack and has an imaginary pivot relative to the base. A drive mechanism is mounted to the base and includes an operation member and an engaging member. The operation member is mounted on the cover along the imaginary pivot of the cover and the operation member is rotatably driven by the cover. The engaging member is disposed on the rack along an axis of the rack and simultaneously drives the rack. The axis of the rack is perpendicular to the imaginary pivot of the cover and the engaging member is laterally engaged to the operation member.

### BACKGROUND OF THE INVENTION

1. Field of the Invention

The present invention relates to a tool box, and more particularly to a tool box that has a rack mounted therein for ordering tools.

2. Description of Related Art

A conventional tool box in accordance with the prior art includes a base and a cover is pivotally connected to the base. An inner frame has two sidewalls and a rack is connected between the two sidewalls. A plurality of recesses is defined in the rack for receiving tool bits therein. A slot is defined through each of the sidewalls and two operation members are connected between the two sidewalls. Each of the operation members has a protrusion which is engaged with the slot corresponding thereto so that when the cover is opened to a certain degree, the rack is pivoted upward.

However, the rack of the conventional tool box in accordance with the prior art is relative to the cover. The rack is simultaneously and upwardly pivoted along a direction in parallel with the cover when the cover is upwardly pivoted. Therefore, the tool bits are hardly gripped by a user in a limited space in the conventional tool box. The conventional tool box needs to be advantageously altered for a convenient operation.

The present invention has arisen to mitigate and/or obviate the disadvantages of the conventional tool box.

### SUMMARY OF THE INVENTION

The main objective of the present invention is to provide an improved tool box that has a receptacle relatively driven by the cover and a rack perpendicular to the receptacle, and the rack is relatively and simultaneously driven by the cover.

To achieve the objective, the tool box in accordance with the present invention comprises a base. A rack is received in the base and pivotally connected to the base for positioning tool bits. A cover is pivotally connected to the base relative to the rack and has an imaginary pivot relative to the base. A drive mechanism is mounted to the base and comprises an operation member and an engaging member. The operation member is mounted on the cover along the imaginary pivot of the cover and the operation member is rotatably driven by the cover. The engaging member is disposed on the rack along an axis of the rack and simultaneously drives the rack. The axis of the rack is perpendicular to the imaginary pivot of the cover and the engaging member is laterally engaged to the operation member.

The engaging member is laterally engaged to the operation member for simultaneously driving the rack and the axis of the rack is perpendicular to the imaginary pivot of the cover when the cover is upwardly pivoted to a specific angle and simultaneously drives the operation member for engaging to the engaging member. The rack is pivoted perpendicular to the cover for providing a spacious operational space such that the cover wouldn't confine operation when a user takes a tool bit.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a tool box in accordance with the present invention;

FIG. 2 is a partially exploded view of the tool box in FIG. 1;

FIG. 3 is an exploded view of the tool box in FIG. 1;

FIG. 4 is a top plan view of the tool box in FIG. 1;

FIG. 5 is a side plan view of the tool box in FIG. 1;

FIG. 6 to FIG. 8 are operational views of the tool box in accordance with the present invention;

FIG. 9 is a schematic view of the tool box in FIG. 8; and

FIG. 10 and FIG. 11 are perspective views of a second embodiment of the receptacle of the tool box in accordance with the present invention.

### DETAILED DESCRIPTION OF THE INVENTION

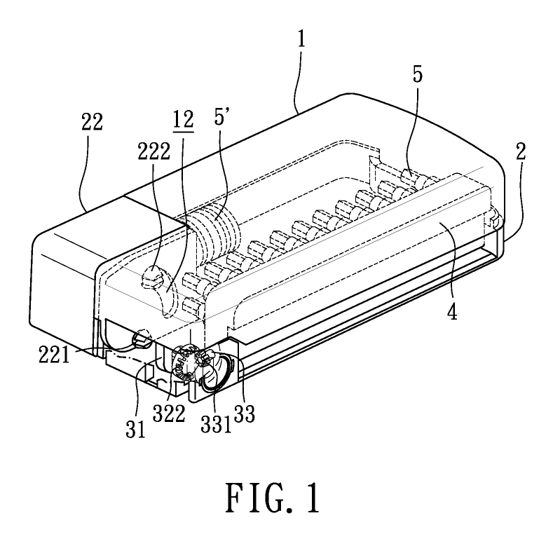

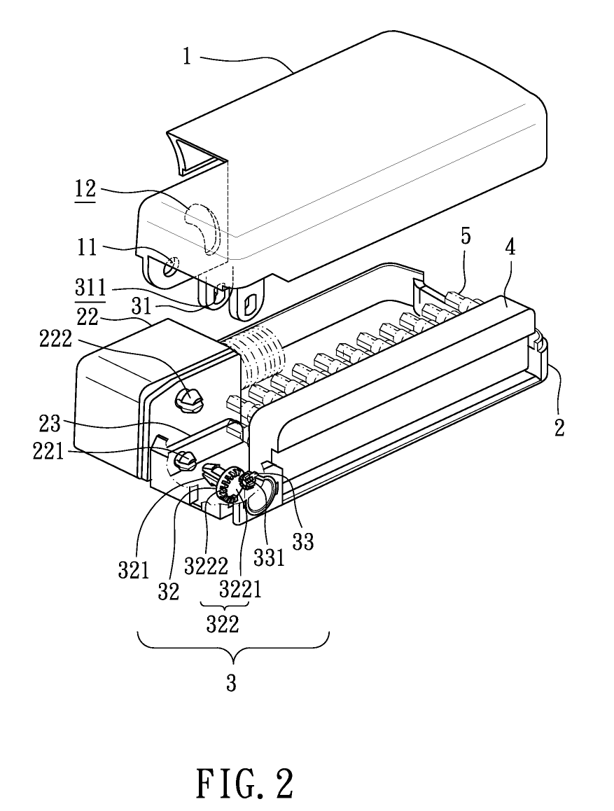

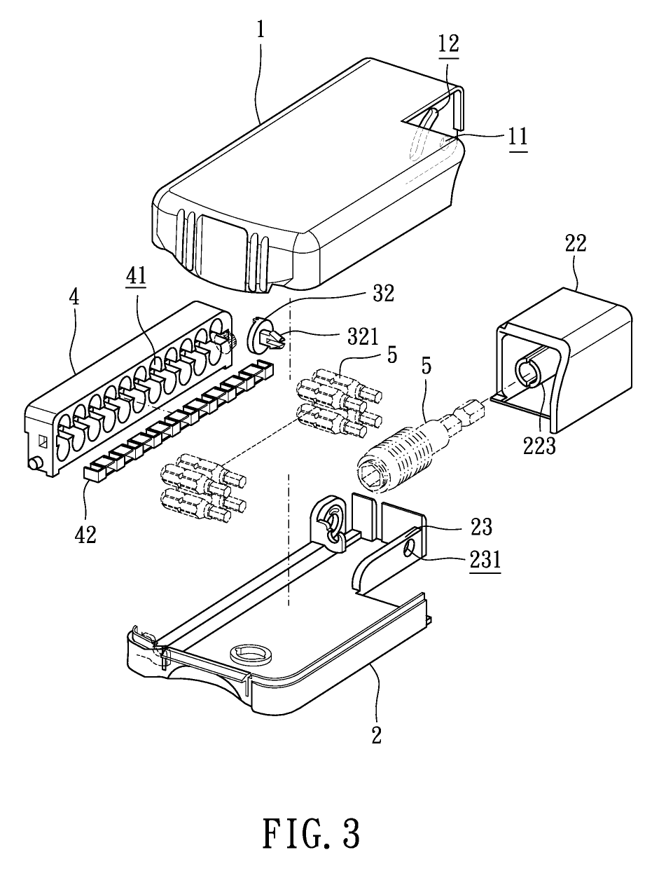

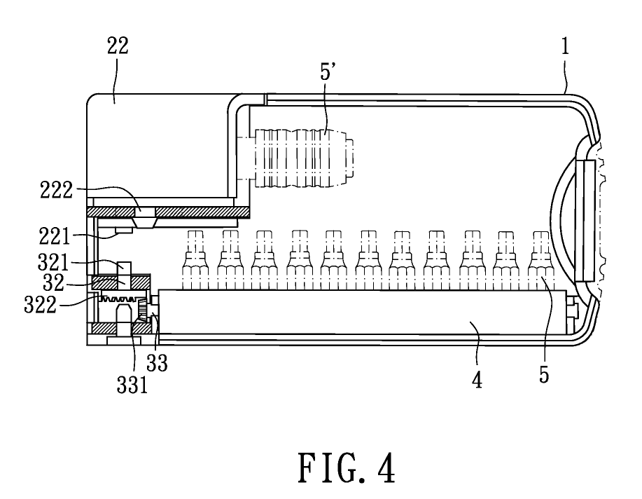

Referring to the drawings and initially to FIGS. 1-5, a tool box in accordance with the present invention comprises a base (2) having a wall (23) longitudinally extending from one side of the base (2). The wall (23) has a connecting hole (231) laterally defined therethrough. A rack (4) is received in the base (2) and pivotally connected to the base (2). The rack (4) has a series of longitudinal recesses (41) defined therein along an axis of the rack (4). A partition (42) is laterally mounted into the series of recesses (41) to divide the series of recesses (41) into a series of first portions and a series of second portions. Each of the series of the first and second portions is adapted to partially receive tool bits (5). A cover (1) is pivotally connected to the wall (23) and has an imaginary pivot relative to the base (2). The axis of the rack (4) is perpendicular to the imaginary pivot of the cover (1). The cover (1) has a connecting hole (11) and an arch groove (12) respectively defined therein, wherein the arch groove (12) corresponds to a center of the connecting hole (11) and having a first end and a second end. An ear (31) is longitudinally formed on a lower end of the cover (1) and a through hole (311) is laterally defined in the ear (31).

A drive mechanism (3) is mounted to the base (2). The drive mechanism (3) comprises an operation member (32) unrotatably mounted to the ear (31) along the imaginary pivot of the cover (1), and an engaging member (33) laterally extending from the rack (4) along the axis of the rack (4) and corresponding to the operation member (32). The operation member (32) has a circular head (322) formed thereon. A protruding member (321) is longitudinally and centrally extending from a first side of the head (322) and a series of first teeth (3222) is formed on a second side of the head (322). In the preferred embodiment of the present invention, the series of first teeth (3222) is arranged as a C-shape to define a non-toothed section (3221). The protruding member (321) extends through and engaged with the through hole (311) in the ear (31) of the cover (1) along the imaginary pivot of the cover (1) for simultaneous rotating with the cover (1). The engaging member (33) has a series of second teeth (331) formed on an outer periphery thereof and selectively engaged with the series of first teeth (3222) for relatively driving the rack (4) when the cover (1) is pivoted relative to the base (2).

A hollow receptacle (22) is pivotally connected to the base (2) and abuts the wall (23) of the base (2). A first protrusion (221) and a second protrusion (222) respectively laterally extend from the receptacle (22), wherein the first protrusion (221) is partially and pivotally received in the connecting hole (231), and the second protrusion (222) extends through the arch groove (12) and moved within the arch groove (12). The first protrusion (221) is linearly aligned with the protruding member (321). A tubular stub (223) extends from a bottom of the receptacle (22) and is adapted to partially receive a bit driver (5′).

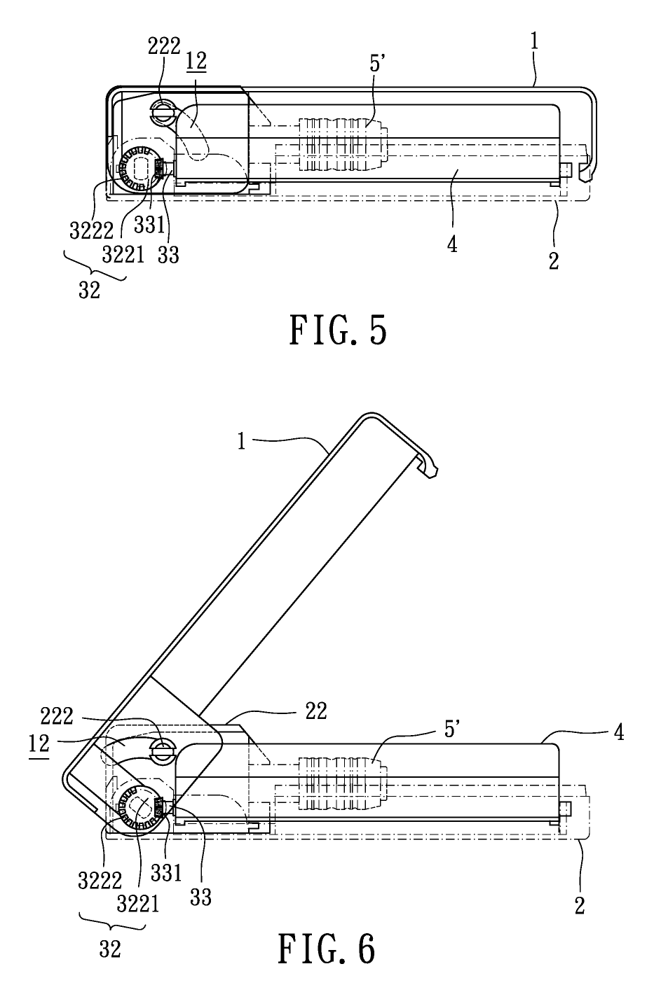

With reference to FIG. 5 to FIG. 7, the second protrusion (222) is situated near the first end of the arch groove (12). The operation member (32) is simultaneously and rotatably driven by the cover (1) and the second protrusion (222) is moved within the arch groove (12) when the cover (1) is moved away from the base (2) relative to the imaginary pivot of the cover (1). At the same moment, the operation member (32) is simultaneously rotated when the cover (1) is pivoted and the engaging member (33) is situated within the non-teethed section (3221) such that the rack (4) is not driven by the operation member (32) to prevent the rack (4) from colliding with the cover (1).

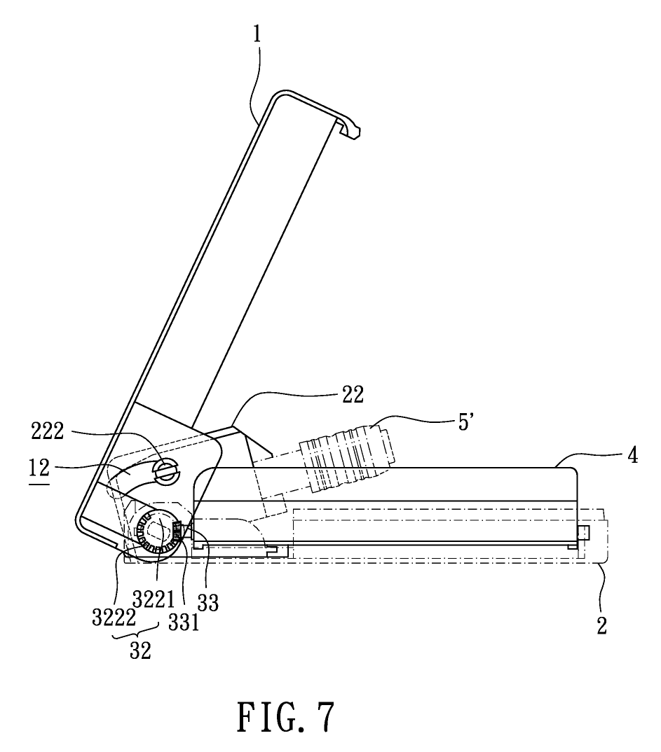

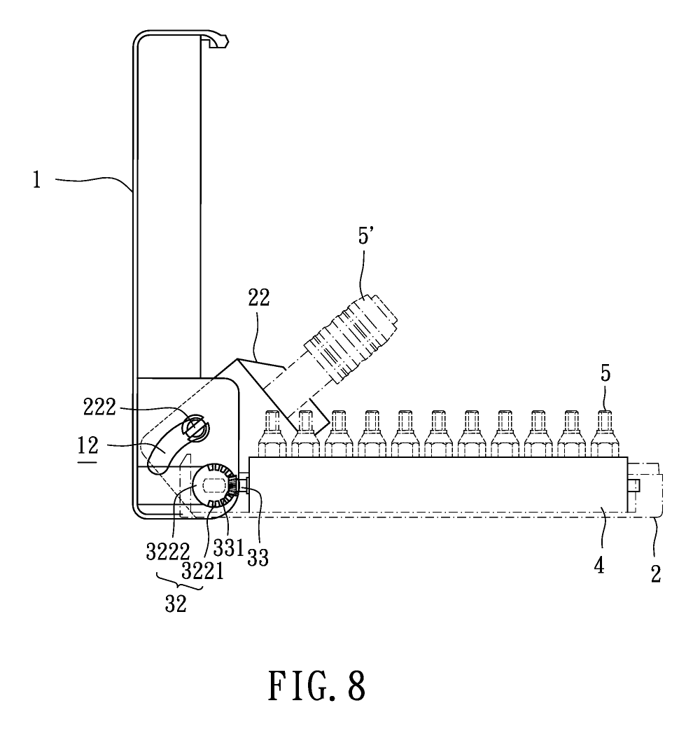

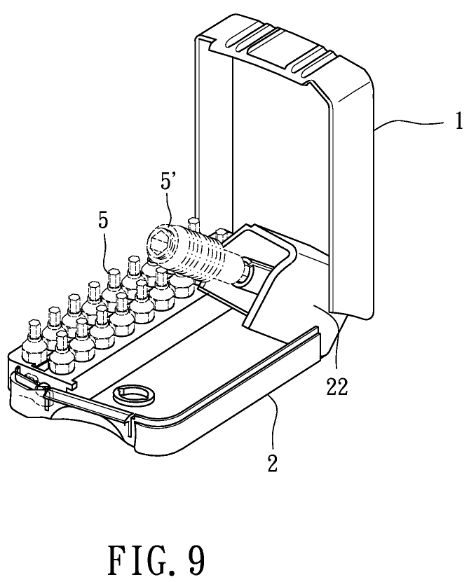

With reference to FIG. 7 to FIG. 9, as the cover (1) continually moved away from the base (2), the series of first teeth (3222) of the operation member (32) is laterally engaged to the series of second teeth (331) of the engaging member (33) for driving the engaging member (33) and turning the rack (4). The engaging member (33) simultaneously drives the rack (4) upwardly pivoted as the axis of the rack (4), and the receptacle (22) is lifted by the cover (1) and co-axially moved relative to the imaginary pivot of the cover (1) after the second end of the arch groove (12) engaged with the second protrusion (22). Therefore, the rack (4) is turned to make the tool bits (5) upwardly extend for easily detaching the tool bits (5) from the rack (4) and the receptacle is inclined relative to the bottom of the base (2) for an easy operation of the bit driver (5′).

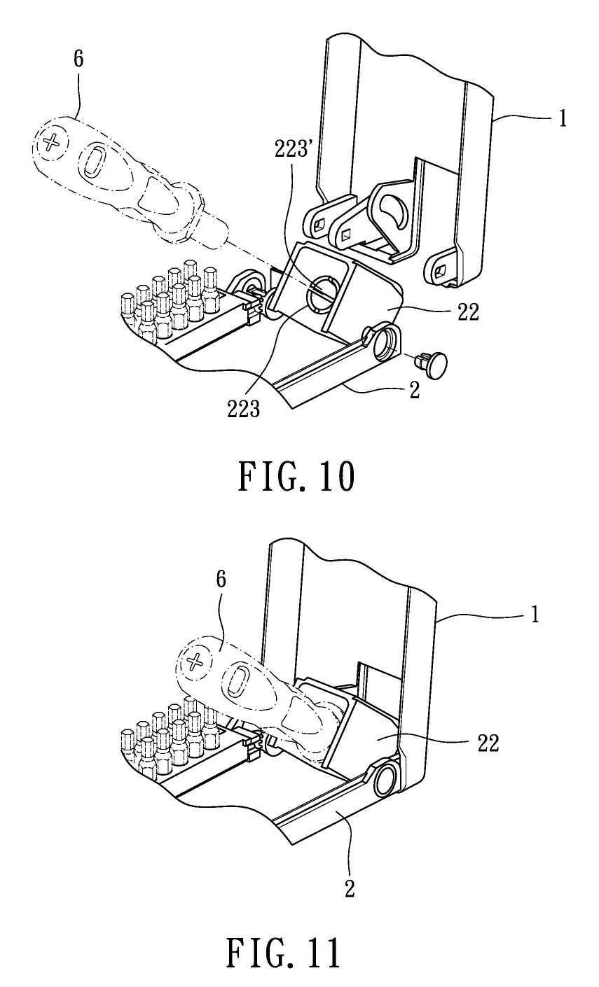

With reference to FIG. 10 and FIG. 11 that show a second embodiment of the tubular stub (223′) of the receptacle (22) in accordance with the present invention, the tubular stub (223′) has a diameter greater than that of the first embodiment of the present invention for partially receiving a tool handle (6).

Although the invention has been explained in relation to its preferred embodiment, it is to be understood that many other possible modifications and variations can be made without departing from the spirit and scope of the invention as hereinafter claimed.

1. A tool box comprising:
a base;
a rack received in the base and pivotally connected to the base, the rack having a series of longitudinal recesses defined therein along an axis of the rack:
a partition laterally mounted into the series of recesses to divide the series of recesses into a series of first portions and a series of second portions, each of the series of first portions and second portions adapted to partially receive tool bits;
a cover pivotally connected to the base and having a pivot relative to the base; and
a drive mechanism mounted to the base and comprising an operation member and an engaging member, the operation member mounted on the cover along the pivot of the cover and the operation member rotatably driven by the cover relative to the pivot of the cover, the engaging member laterally disposed on the rack along the axis of the rack and simultaneously driving the rack, the axis of the rack being perpendicular to the pivot of the cover, the engaging member laterally and selectively engaged to the operation member;
whereby the engaging member is laterally and selectively engaged to the operation member when the cover is upwardly pivoted and simultaneously drives the operation member for selectively engaging to the engaging member and relatively turning the rack.

2. The tool box as claimed in claim 1, wherein the operation member has a head formed thereon, a series of first teeth partially and longitudinally formed on one side of the head, the engaging member having a series of second teeth formed on an outer periphery thereof, the series of second teeth laterally and selectively engaged with the series of first teeth for driving the rack when the cover is pivoted relative to the base.

3. The tool box as claimed in claim 2, wherein the series of first teeth is arranged as a C-shape to define a non-toothed section such that the operation member is idle when the engaging member is situated within the non-toothed section.

4. The tool box as claimed in claim 2, wherein the cover has an ear longitudinally formed on an lower end thereof and a through hole laterally defined in the ear, a protruding member longitudinally and centrally extending from the head opposite to the series of first teeth, the protruding member extending through and engaged with the through hole in the ear of the cover along the imaginary pivot of the cover for simultaneously rotating with the cover relative to the pivot of the cover.

5. The tool box as claimed in claim 1 further comprising a receptacle pivotally connected to the base, and having a first protrusion and a second protrusion respectively laterally extending therefrom, a wall longitudinally extending from one side of the base for pivotally connecting to the receptacle and having a connecting hole laterally defined therethrough, the first protrusion partially and pivotally received in the connecting hole in the wall, the cover having a arch groove laterally formed therethrough, the second protrusion extending through the arch groove and moved within the arch groove for inclining the receptacle relative to the base when the cover is pivoted.

6. The tool box as claimed in claim 5, wherein the receptacle has a tubular stub extending from a bottom thereof and adapted to partially receive a bit driver.

7. (canceled)

8. (canceled)
